(19) United States
(12) Patent Application Publication
(10) Pub. No.: US 2004/0044693 A1
(43) Pub. Date: Mar. 4, 2004

(54) Automated logging of system configurations

(76) Inventors: Andrew Hadley, Colorado Springs, CO (US); Mark Slutz, Colorado Springs, CO (US); David So JR., Colorado Springs, CO (US); Carl Gygi, Colorado Springs, CO (US)

Correspondence Address: LSI LOGIC CORPORATION, 1621 BARBER LANE, MS: D-106 LEGAL, MILPITAS, CA, 95035, US

(21) Appl. No.: 10/230,842

(22) Filed: Aug. 27, 2002

(51) Int. Cl. G06F 17/30

(52) U.S. Cl. 707/200

(57) ABSTRACT

Disclosed is a system and method for determining the configuration of a personal computer and storing the configuration for further use, such as administrative analyses. The configuration of a personal computer may be stored locally or in a database located on a network and shared with a plurality of other personal computers.

### BACKGROUND OF THE INVENTION

a. Field of the Invention

The present invention pertains generally to administration of personal computer systems and specifically to the tracking and monitoring of personal computer system configurations.

b. Description of the Background

In situations where many personal computers exist, managing the configurations of the various computers is a complex and difficult task. Personal computers have a plethora of hardware, software, and firmware variations, all of which may or may not be significant to an administrator of the computer systems.

For example, in a test lab environment, a hundred different computer systems may be operating to test a specific card, chip, or piece of software. These computer systems may be intentionally configured differently from each other to try to identify compatibility problems. During the course of testing, the various computer systems may be changed or reconfigured on an on-going basis. After the test has been completed, an analysis may compare the various errors with the specific configuration of the computer on which the error occurred.

In another example, a system administrator in a large corporation may be in charge of many hundreds of computer systems. During day-to-day operations, the configurations of these hundreds of computers may be important data. For example, periodic updates to software may need to be installed to those systems running a specific version of an application, or specific systems may be targeted for upgrading. For technical support calls, a computer technician may be better able to help a frustrated caller when the technician can view the details of the caller's system configuration or know when the caller's computer has been changed.

It would therefore be advantageous to provide a system and method for capturing the configuration of a personal computer system and store a configuration description for further analysis.

### SUMMARY OF THE INVENTION

The present invention overcomes the disadvantages and limitations of the prior art by providing a system and method for capturing and storing a personal computer configuration. The present invention further allows the storing of the configuration information locally or on a network database. With a network database, an administrator may view the configurations of many computer systems simultaneously. The present invention allows for optional alerts to be generated when a configuration changes.

The present invention may therefore comprise a method for storing the configuration of a personal computer comprising: determining at least a portion of the current configuration of said personal computer automatically; reading a configuration file containing an old configuration of said computer; comparing said current configuration to said old configuration to determine any changes; and if any changes exist, creating an alert and updating said configuration file with said current configuration.

The present invention may further comprise a personal computer with an automatically updated configuration file comprising: a local storage device comprising a configuration file comprising at least a portion of a stored configuration of said personal computer; and a software program adapted to determine at least a portion of the current configuration of said personal computer automatically, read a configuration file containing an old configuration of said computer, compare said current configuration to said old configuration to determine any changes, and if any changes exist, create an alert and update said configuration file with said current configuration.

The present invention may further comprise a system for automatically maintaining and storing configuration information about a plurality of personal computers comprising: a storage device comprising a configuration database comprising a record for each of said plurality of personal computers, each of said records comprising at least a portion of the configuration of said personal computer, said storage device connected to a network; said plurality of personal computers adapted to determine at least a portion of the current configuration of said personal computer automatically and communicate said configuration to said configuration database; at least one analysis device capable of comparing said current configuration of said personal computer with an old configuration that was stored in said configuration database; and at least one administrative device capable of recalling said records from said configuration database.

The advantages of the present invention are that configurations of computing devices are automatically documented, alleviating any errors due to incomplete or inaccurate data collection and entry. The configuration changes may be logged so that the history of the configurations may be referenced when correlating to events such as test results or a problem with the computer.

### BRIEF DESCRIPTION OF THE DRAWINGS

In the drawings,

FIG. 1 is an illustration of an embodiment of the present invention of a networked system for storing configuration data in a database from a plurality of computers.

FIG. 2 is an illustration of a work flow diagram of an embodiment of the present invention for a method of capturing and storing configuration data.

### DETAILED DESCRIPTION OF THE INVENTION

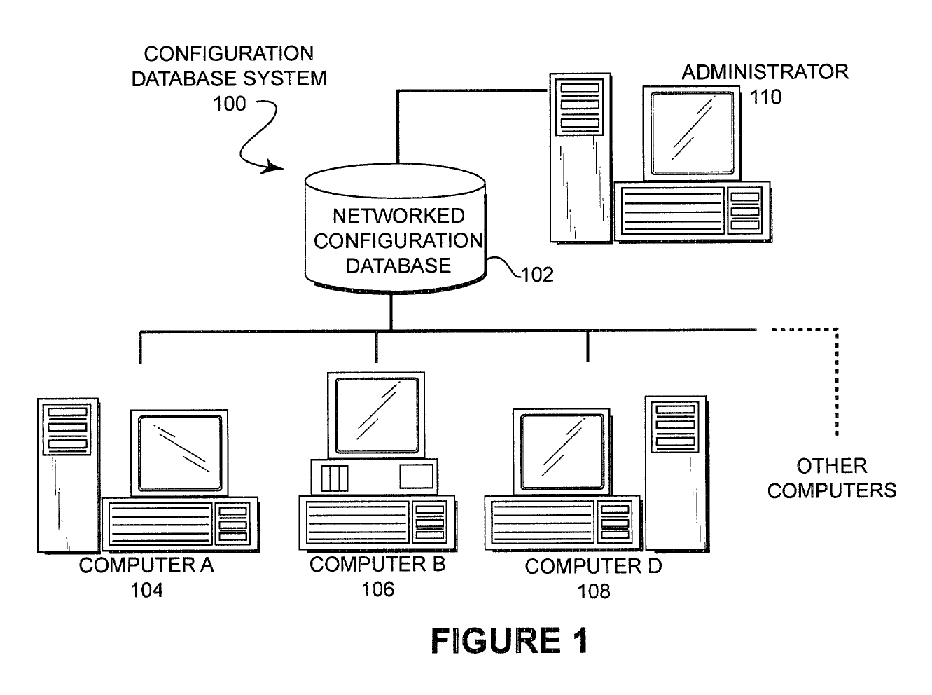

FIG. 1 illustrates a networked system 100 for storing configuration data in a database 102 from a plurality of computers 104, 106, and 108. An administrator 110 is also connected to database 102. Each computer 104, 106, and 108 may periodically determine its own configuration and send the configuration information to the database 102. The database 102 may log each change to the configuration for a particular computer for cross reference at a later time.

The computers 104, 106, and 108 may be computers in a test laboratory environment. In such an environment, many computers of various configurations may be used to simultaneously test a particular hardware accessory, peripheral, software program, chipset, firmware, or any other device connected to or part of a computer. During the course of a test, various failures or errors may occur. At the end of the test, the failures may be analyzed against the configuration database 102 to determine if a specific hardware, software, or firmware configuration may be a particular problem.

A test laboratory may have a wide variety of computers in a wide variety of configurations. Further, new computers, new peripherals, new software, and other new products are constantly being developed and released. Thus, a test laboratory may be continually upgrading and changing configurations so that the laboratory can evaluate a product on the latest equipment. It is common in a test lab to write the configuration parameters on a sheet of paper or enter the parameters into a spreadsheet. However, the sheer number of parameters leads to problems of incompleteness, inconsistency, and inaccuracy.

A detailed hardware configuration of computer may include the manufacturer, type, and frequency of the CPU; memory size and speed; front side bus frequency; cache size; PCI north bridge type; the model number, revision number, overall description, slot address, and other parameters for each and every PCI device; manufacturer, model number, and revision of any CD-ROM, DVD-ROM, floppy drives, or other removable storage devices; manufacturer, model number, size, and revision of any IDE hard drives; manufacturer, model number, and revision number of any advanced graphics port (AGP) devices or other video graphics devices; BIOS version; additional PCI chipsets; or any other parameter that might be deemed necessary to define the hardware configuration. In a similar fashion, the various software components may include the version and service pack history of the operating system, versions and descriptions of each driver loaded, version of each application, and any other software related parameter that is deemed necessary to track. Firmware, such as BIOS versions and the revisions of various firmware components on various cards and peripherals may also be tracked. The preceding list is meant for example only and is not exhaustive. Those skilled in the art will appreciate that many different parameters may be capable of being tracked with the present invention. Such parameters may be determined by the specific application and embodiment of the present invention.

With a manual method of data tracking, the data may be subject to inconsistency and inaccuracy by a technician. For example, one technician may define a parameter with one word while another technician may define a parameter with a different word.

Manual data collection is subject to incompleteness. The sheer number of parameters required to fully define a configuration of a computer may take a great deal of time to determine and log manually. Further, the frequency with which computers in a test lab are updated and changed makes the collection of accurate data difficult.

An embodiment may use a software program operable on a personal computer to query and log the various parameters for the configuration information. The use of a software program has the benefit of providing a uniform consistency to the data. Further, a detailed parameter such as revision designation for a hardware peripheral, for example, may only be detectable by either a software query or by disassembling a computer to examine a label on the hardware component. Therefore, the software program of the present invention may also be able to detect information much more detailed than would be practical with a manual data collection method.

An embodiment may store the configuration information in a format that can be easily retrieved and manipulated by a database management system or other software program.

The configuration information may be stored locally on the personal computer in addition to the networked database 102. For example, a personal computer may store a configuration file on a local hard drive. When the configuration of a personal computer is determined using the present invention, the locally stored copy of the configuration may be compared to the newly generated configuration to determine any differences. If differences exist, the configuration file may be updated. In some cases, an alert may be generated.

The term personal computer used herein shall be used to denote any computational device capable of running a software program to determine its configuration and connect to a network such as a personal computer, laptop computer, handheld computer, server, internet appliance, or other computer. In addition, network capable devices, such as certain electronic instruments, test and measurement equipment, servers, remotely controlled switches, and various appliances may also benefit from the present invention.

Another use for an embodiment of the present invention is for the administration of large computer networks. For example, in a corporation having several computers to several thousand computers, the tracking and management of all the devices is a difficult task. The administrators tasked with maintaining and updating all of the computers located throughout a facility may need to identify computers with certain peripherals for upgrading, or may need to update certain users with new software components as they are made available. Further, an accurate, detailed configuration of every computer may be used to identify those computers that need upgrading or where certain users have unused capability that may be better suited for a different user.

An administrator of a corporate network of computers may wish to be notified when a change is made to a configuration. For example, if a user removes memory from one computer and places the memory in another computer, thus altering the configuration, an alert may be sent to the administrators that certain changes have been made. Unauthorized changes may be investigated. In another example, if a technician is dispatched to perform an upgrade, the changed configuration may verify that the change was implemented correctly.

In another use for an embodiment of the present invention, a computer help desk may query the configuration database 102 to find the specific, detailed configuration of a caller's computer when giving assistance. The detailed configuration may help the technician in identifying specific solutions to the caller's needs without asking the caller to determine information about their computer manually.

The specific configuration parameters that are stored in the example of a test laboratory may be different from those stored in the corporate computer administrator example. For example, the specific revision of firmware in a graphics processor board may be important for the testing of a graphics driver. However, for the corporate computer administrator, only the make and model number, or even just the overall performance category of the graphics processor may be necessary. In other applications of the present invention, the specific parameters that are gathered and stored may be tailored to meet the specific needs of the application. Those skilled in the art may appreciate that many different parameters may be logged and stored automatically using the present invention without deviating from the spirit and intent of the present invention.

In yet another embodiment of the present invention, the configuration data may be incorporated into an error log. For example, in a situation where tests are being performed, such as field beta testing hardware or software or in a testing laboratory, when an error is generated, the configuration data may be stored as part of an error log. In other embodiments, the error log may have a time stamp that is correlated to the configuration database when the error log is analyzed, resulting in a detailed configuration of the computer at the time of the error. These data may assist an engineer or technician in determining if certain configuration parameters may have caused the error.

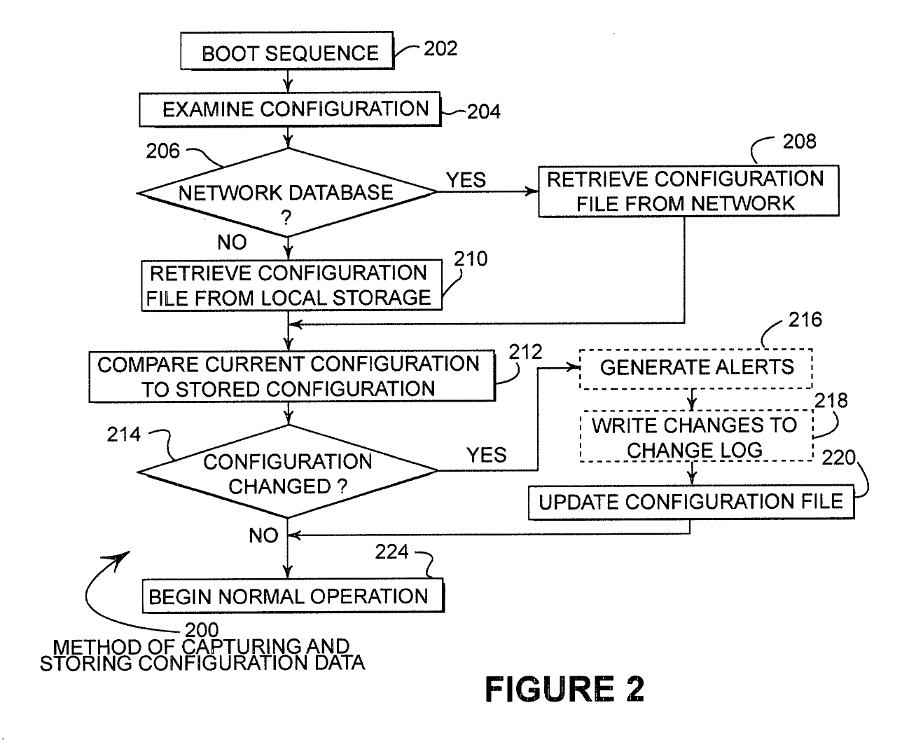

FIG. 2 illustrates a work flow diagram of an embodiment 200 of the present invention for a method of capturing and storing configuration data. After a boot sequence 202, the configuration of the device is determined 204. If the embodiment is a network based system 206, a configuration file may be retrieved from the network database 208, otherwise, a configuration file may be retrieved from a local storage device 210. The current configuration is compared to the previously stored configuration 212. If any changes exist 214, an optional alert is generated 216, changes are written to a change log 218, and the configuration file is updated 220, after which, normal computer operations are resumed 222.

The present invention may be a normal part of the boot sequence for the computing device. In the present embodiment 200, the configuration would be detected upon each start up of the computer. As technology advances, ‘hot docking’ devices may be installed and run on a computer without the need to reboot the computer. As such, these devices would only be detected if the computer were to be restarted for some reason. In some embodiments, the present invention may be executed once a day or some other periodic interval and thus not necessarily be part of a start up sequence.

The process of examining the configuration 204 may involve several queries to the hardware, software, and firmware. For example, on some computers, it is possible to query various device's manufacturer and model number and even firmware revision number. Commands are available to query the installed PCI cards and retrieve various information concerning the cards. Such calls can be done completely through software control without any operator input. The calls made by the present invention are chosen to generate the information necessary for the intended use of the data. For the example of the test laboratory, the specific firmware version of a specific peripheral may be of importance whereas for the system administrator for a large corporation that data would not be useful.

The connection to the network 206 may direct the computer to retrieve the configuration file from a network location 208. In some embodiments, the network location may contain a database of many records, one for each computer. The query to the database may retrieve the particular record for the particular computer. In some embodiments with a network, a copy of the configuration file may also be kept on the local storage device of the computer. In such an embodiment, the connection to the network database may only be used when a change exists to the configuration.

The current configuration is compared against the stored configuration 212 to determine if the configuration has changed. If the configuration has changed 214, an alert may be generated 216, the changes logged 218, and the configuration file updated 220. In some cases, an alert may consist of an email message to a specific person, such as an administrator or other responsible party. For example, in the case where the present invention is used in a corporate administration function, a work order to update a user's computer may cause a technician to perform the upgrade. The alert may serve as proof of completion of the upgrade task. Such alerts may be sent to the user as well as the technician's supervisor. In other embodiments, the alert may be stored in a log that may be reviewed by an administrator to detect any unauthorized changes to the computer systems.

The changes may be logged 218 to document the individual changes when they are made. In some instances, the change log history may be a valuable tool in finding any changes made to a computer system if a problem occurred. For example, if a test were run in a test laboratory environment and a particular problem was observed with a particular computer, the change log history of that computer may be consulted to determine the exact configuration when a problem was observed. The change log may be in addition to a database of current configurations.

The configuration file may be updated 220 when changes are detected. In other embodiments, the configuration file may be updated whenever the configuration is detected so that the data contained in the configuration file is known to be current.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for storing the configuration of a personal computer comprising:
determining at least a portion of the current configuration of said personal computer automatically;
reading a configuration file containing an old configuration of said computer;
comparing said current configuration to said old configuration to determine any changes; and
if any changes exist, creating an alert and updating said configuration file with said current configuration.

2. The method of claim 1 wherein said current configuration comprises at least a portion of the hardware configuration of said personal computer.

3. The method of claim 1 wherein said current configuration comprises at least a portion of the software configuration of said personal computer.

4. The method of claim 1 wherein said current configuration comprises at least a portion of the firmware configuration of said personal computer.

5. The method of claim 1 wherein said configuration file is located on a second computer connected to said personal computer by a network.

6. The method of claim 5 wherein said alert comprises sending an email.

7. The method of claim 5 wherein said configuration file comprises a record in a database.

8. The method of claim 1 wherein said configuration file is accessible to a second computer connected to said personal computer by a network.

9. The method of claim 1 wherein said method is executed during a startup sequence of said personal computer.

10. A personal computer with an automatically updated configuration file comprising:
a local storage device comprising a configuration file comprising at least a portion of a stored configuration of said personal computer; and
a software program adapted to determine at least a portion of the current configuration of said personal computer automatically, read a configuration file containing an old configuration of said computer, compare said current configuration to said old configuration to determine any changes, and if any changes exist, create an alert and update said configuration file with said current configuration.

11. The personal computer of claim 10 wherein said current configuration comprises at least a portion of the hardware configuration of said personal computer.

12. The personal computer of claim 10 wherein said current configuration comprises at least a portion of the software configuration of said personal computer.

13. The personal computer of claim 10 wherein said current configuration comprises at least a portion of the firmware configuration of said personal computer.

14. The personal computer of claim 10 wherein said configuration file is accessible to a second computer connected to said personal computer by a network.

15. The personal computer of claim 10 wherein said method is executed during a startup sequence of said personal computer.

16. A system for automatically maintaining and storing configuration information about a plurality of personal computers comprising:
a storage device comprising a configuration database comprising a record for each of said plurality of personal computers, each of said records comprising at least a portion of the configuration of said personal computer, said storage device connected to a network;
said plurality of personal computers adapted to determine at least a portion of the current configuration of said personal computer automatically and communicate said configuration to said configuration database;
at least one analysis device capable of comparing said current configuration of said personal computer with an old configuration that was stored in said configuration database; and
at least one administrative device capable of recalling said records from said configuration database.

17. The system of claim 16 wherein at least one of said personal computers is said analysis device.

18. The system of claim 17 wherein each of said personal computers is said analysis device.

19. The system of claim 16 wherein said administrative device is also said analysis device.

20. The system of claim 16 wherein said current configuration comprises at least a portion of the hardware configuration of said personal computer.

21. The system of claim 16 wherein said current configuration comprises at least a portion of the software configuration of said personal computer.

22. The system of claim 16 wherein said current configuration comprises at least a portion of the firmware configuration of said personal computer.

23. The system of claim 16 wherein said alert comprises sending an email.

24. The system of claim 16 wherein said personal computer executes said determining at least a portion of said configuration during a startup sequence of said personal computer.
